(19) United States
(12) Patent Application Publication
(10) Pub. No.: US 2004/0216624 A1
(43) Pub. Date: Nov. 4, 2004

(54) Press roll

(76) Inventors: Uwe Matuschczyk, Geislingen (DE); Dirk Thomas, Heidenheim (DE); Jens Muller, Heidenheim (DE)

Correspondence Address: TAYLOR & AUST, P.C., 142 SOUTH MAIN STREET, P. O. BOX 560, AVILLA, IN, 46710, US

(21) Appl. No.: 10/850,683

(22) Filed: May 21, 2004

(30) Foreign Application Priority Data
Nov. 29, 2001 (DE) 101 58 717.1

(51) Int. Cl. B30B 3/02

(52) U.S. Cl. 100/156

(57) ABSTRACT

A press roll for forming a press nip with an other press roll including a rotating roll shell, a roll axle and a supporting device connected to the roll axle. The supporting device supports the rotating roll shell. An end wall is associated with the press roll. At least one supporting shoe is connected to the supporting device, the at least one supporting shoe removable from the press roll through the end wall.

### BACKGROUND OF THE INVENTION

1. Field of the Invention

The invention relates to a press roll for forming a press nip with another press roll, and, more particularly to, a rotating roll shell, a roll axle and a supporting or load bearing device, which is connected to the roll axle and supports the roll shell, and also a method of changing the supporting device.

2. Description of the Related Art

In press rolls friction causes wear of the roll shell and supporting device occurs. In particular, changing the supporting device, which is consequently required for this reason, is generally difficult and time-consuming. Because of the restricted accessibility, particularly in machines for the production and/or finishing of fibrous webs, this often requires that the entire press roll be removed.

What is needed in the art is a simple way of changing the supporting device or at least a part thereof in press rolls.

### SUMMARY OF THE INVENTION

In one form of the invention, there is at least one supporting or pressure shoe that is connected to the supporting or load bearing device and is arranged such that it can be removed from the press roll through an end wall of the press roll. The supporting or pressure shoe can be removed from the press roll easily and without great effort. All without the entire press roll having to be dismantled. Advantageously, in one embodiment of the present invention there is a supporting device that is arranged pivotally within the roll shell. This makes it possible for the supporting device to be pivoted out of the working position into a changing position, before the change. In this case, the pivoted position is characterized by improved accessibility, so that the change can be carried out more quickly and without removing the entire press roll.

Depending on the type of press roll and, in particular, the type of supporting device, the supporting device is pivotable together with the roll axle or the supporting device is pivotally arranged on the roll axle.

The present invention offers particular advantages in the case of press rolls whose supporting device includes a supporting shoe that is pressed against the roll shell, the pressing preferably being carried out hydraulically. The pressurized fluid is led via the roll axle to the respective supporting device. The supporting device being a plurality of supporting devices arranged axially beside one another in the press roll.

In machines for the production and/or conversion of paper, board, tissue or other fibrous webs, it is advantageous, during the dewatering or calendering of the fibrous web, for the roll shell to be of a flexible design and the supporting shoe to have a concave pressing surface for forming an extended press nip. If the press roll is arranged above the other press roll of the press nip, then it is advantageous, with respect to accessibility, if the supporting device can be pivoted between 90° and 270°, preferably by about 180°. In another case, specifically when the press roll is arranged under the other press roll of the press nip, that the supporting device should be pivotable between 90° and −90°, preferably between 45° and −45°.

In an advantageous development of the present invention, there is at least one supply line for supplying a hydraulic fluid to the pressure piston, for pressing the pressure shoe against the inner wall of the roll shell. There can also be a plurality of pressing pistons that can be actuated individually or jointly in the direction of the roll axle. Thus, both the central zones and the edge zones of the pressure shoe have a unit assigned to them for applying the necessary pressure.

According to the present invention, the supply lines can be specially configured. For example, the supply lines are lines for a hydraulic fluid, in particular hydraulic oil, that is to say the supply lines are pressure lines. Supply lines of this type, in particular the hydraulic lines, each have a disconnection point. Quick-action couplings are preferably used as disconnection points. The disconnection points are advantageously arranged underneath the roll shell, in the vicinity of an end cover of the press roll. This ensures good accessibility.

The disconnection points are configured so that the inner pipeline parts can be moved with respect to the outer. That is to say, parts arranged closer to the roll shell, can be raised or rotated. The ability to rotate is ensured, for example, by rotary couplings. By way of the rotary couplings, the tightness at the connecting point between the outer and the inner line parts is ensured. The supply lines run through the interior of a fixed axle into the interior of the press roll.

The supply lines include lubricating lines, which are under hydrostatic pressure, and/or measuring lines, which belong to a hydraulic system and measure the pressure in the pressure lines for applying the pressing pressure for the pressure shoe. Likewise, lines are provided for lubricating oil.

The supply lines, at least in the region in which the load bearing or supporting device carries out a rotary movement or a translational movement, are of a flexible design. For example, the supply lines may be a hose, a cable or another flexible line, in order that they can follow the movement of the supporting device. The supporting device and, in particular, the supporting shoe are always supplied with the requisite medium, for example pressurized oil.

If for example, the pressure or supporting shoe has a length of 120 mm, a minimum displacement of more than 7 mm, but preferably of more than 10 to 15 mm, is provided. If the supporting shoe has a length of 270 mm, a minimum displacement of more than 10 mm, but preferably of more than 15 to 20 mm, is provided; if the supporting shoe has a length of more than 300 mm, a minimum displacement of more than 20 mm is provided. These dimensions apply relative to drying a paper web for a graphic paper, but also generally for white and brown paper.

For material webs of paper and tissue, a press roll suitable to be used as a backing roll is one which has a diameter of more than 1000 mm, preferably a diameter in the range of between 1000 and 1600 mm, while the supporting shoe has a length of more than 120 mm. In the case of a press roll for use exclusively for tissue webs, the press roll has, for example, a diameter in the range of between 2500 and 5500 mm and the supporting shoe has a length of less than 150 mm.

According to one embodiment of the present invention, the removal of the pressure shoe from the press roll is made easier by the fact that the spacing of the press rolls is enlarged. This is done, for example, by the spacing of the bearing walls or the bearing housings being enlarged. In this case, either the press roll containing the pressure shoe or the press roll used as a backing roll is displaced by a fixed distance from the other press roll. The movement is preferably carried out by way of one or more hydraulic cylinders.

In one embodiment of the present invention, the end cover, that is to say the clamping disk, can also be dismantled. Instead of removing the entire end cover, provision is made for there to be only one removal opening at the end of the press roll, through which the supporting shoe can be removed from the press roll. In order to prepare a change of the supporting shoe, as described above, the spacing between the press roll and the press roll is enlarged. During the enlargement of the spacing, it may also be necessary for supply lines to be isolated. As such, the coupling elements that can be disconnected are arranged in the supply lines. The supporting apparatus, with the pressure shoe, is then rotated out of the operating position through a fixed angle. The pressure shoe is removed through an end opening in the press roll and through a removal opening or a cutout in the bearing wall in which the press roll is mounted. Alternatively, the cover at the end is moved to the side or removed as a whole. The supporting shoe is then moved out or pulled out in the direction of the longitudinal axis of the press roll. When the supporting shoe is replaced by another supporting shoe, the installation steps are completed in the reverse order.

Some reasons for the rapid removal of a supporting shoe are for replacement due to wear, or in an adaptation of the geometry of the supporting shoe relative to production and quality requirements such as different paper grades. For instance, for specific paper qualities, the specific volume is a critical quality feature, which requires gentle dewatering, for which a longer supporting shoe with an adapted pressure profile is used.

For a high production throughput, it is critical that a high dewatering performance be achieved. For this purpose, a high dewatering pressure is used to achieve a high level of dryness, so that there is little time expended on drying.

Another reason for changing the supporting shoe is when the latter is damaged, which may occur at the passage of a thickening in the paper web (passage of a lump) or in the event of felt damage.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic cross section through a press roll of an embodiment of the present invention;

FIG. 2 shows a cross section through a press roll of another embodiment of the present invention;

FIG. 3 shows a longitudinal cross section through the press roll of FIGS. 1 and 2;

FIG. 4 shows a cross section through the press roll of FIG. 3;

FIG. 5 shows a cross section through a press roll having a pressure shoe, which is arranged underneath a press roll serving as a backing roll;

FIG. 6 shows an enlarged detail from FIG. 5; and

FIGS. 7 to 10 illustrate the positioning of a press roll in various positions for the removal of the pressure shoe of the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

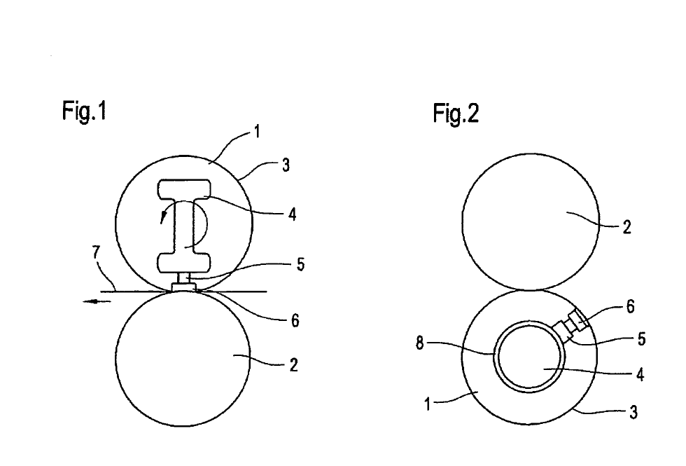

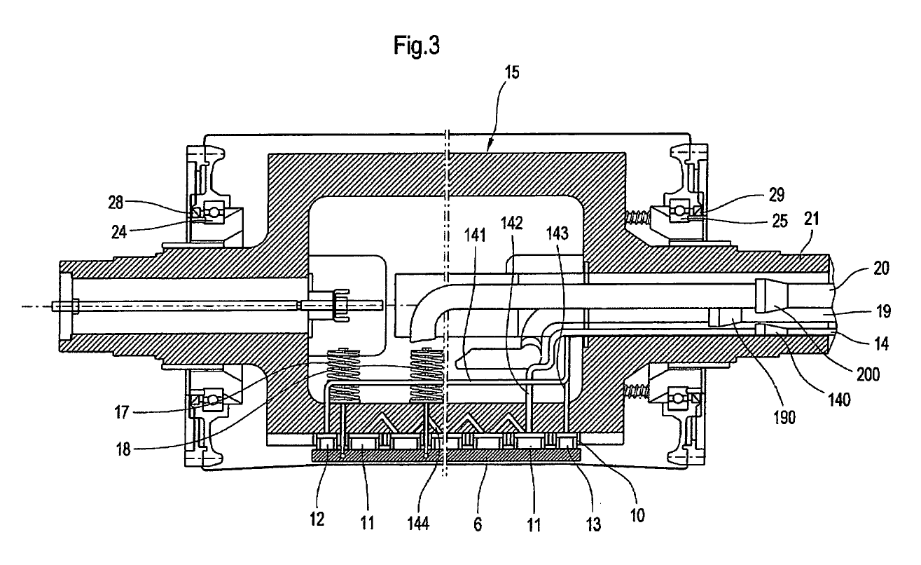

Referring now to the drawings, and more particularly to FIGS. 1 and 2, there is illustrated a press roll 1, and another press roll 2, which forms a press nip for treating a material web 7. Material web 7 may be a paper, board, tissue or another fibrous web 7. In the case of calendering, fibrous web 7 runs through the press nip by itself. In the case of the dewatering of fibrous web 7, at least one endlessly circulating belt is also guided through the press nip in order to pick up the water pressed out of web 7.

Press roll 1 has a flexible roll shell 3 and a roll axle 4 with a supporting device 5. Supporting device 5 is responsible for pressing roll shell 3 toward press roll 2. Supporting device 5 has a supporting shoe 6, which has a concave pressing surface that forms an extended press nip.

As shown in FIG. 1, press roll 1 is arranged above press roll 2 and supporting device 5 is firmly connected to roll axle 4. Since the accessibility in this position is normally particularly restricted, roll axle 4 with supporting device 5 can be pivoted by up to 270°. In the event of a change of supporting device 5, or a part thereof, such as supporting shoe 6, supporting device 5 can be pivoted out of the working position into a changing position. In the changing position the accessibility to shoe 6 is substantially better. The changing position depends on the type of machine unit and also the specific configuration.

As shown in FIG. 2, a press or calendering apparatus has a press roll 1 that is arranged under press roll 2. In addition, supporting device 5, with its supporting shoe 6, is pivotally mounted on roll axle 4 by way of a ring 8, so that roll axle 4 can be fixed. Here, supporting device 5 is illustrated in a changing position being rotated approximately −45°.

Since the lower position of press roll 1 is normally more easily accessible, the ability to pivot supporting device 5 through a small angle provides a significant advantage. Of course, both press rolls 1 and 2 can have a pivotable supporting device 5.

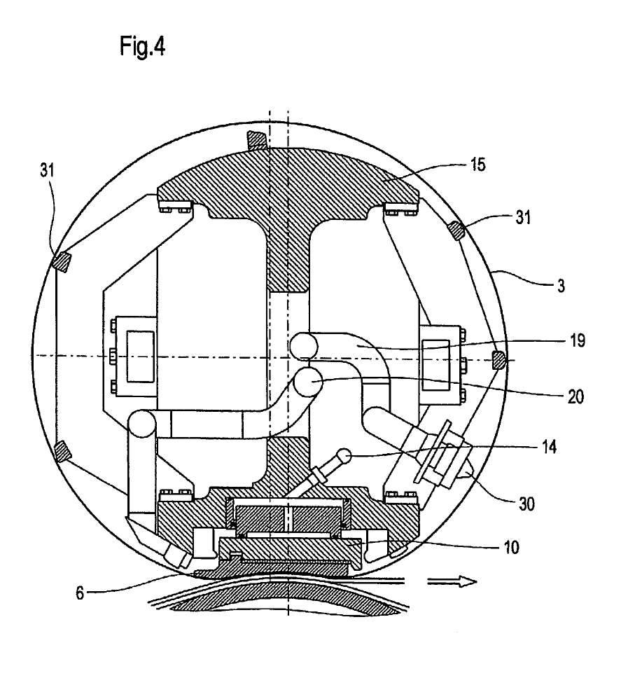

Now, additionally referring to FIG. 3 there is shown a press roll 1 corresponding to the width of material web 7 from which moisture is to be removed. There is a single supporting shoe 6, also known as a pressure shoe 6, which is pressed against roll shell 3 by a single supporting device 5 or by a plurality of supporting devices 5. Supporting device 5 includes a pressing element, in which there are a plurality of pressure regions 11 for pressing supporting shoe 6 against roll shell 3 and thus against press roll 2 used as the backing roll. Arranged in the edge zone of pressure shoe 6 are relief elements 12 and 13, which have a smaller pressing area than pressure regions 11 with supporting shoe 6, so that only a low pressure is built up in this edge region. Pressure regions 11 and relief regions 12 and 13 are jointly supplied with pressurized oil by way of a line 14. Arranged in line 14 is a detachable connection 140, which makes it possible, during a pivoting or a displacement movement of supporting device 5 and of supporting or pressure shoe 6 connected to the latter, to keep a load bearing element 15 that holds supporting device 5 in a fixed location while supporting device 5 is moved.

Line 14 is divided into a plurality of lines 141, 142 and 143, which are used to supply pressure regions 11 or relief regions 12 and 13 with pressurized oil. Pressure regions 11 are interconnected by way of connecting lines 144. If no pressure is exerted on supporting shoe 6 by way of the hydraulic system of pressure regions 11 and relief regions 12 and 13, supporting shoe 6 is pulled back into a position in which it is lifted off of roll shell 3 by return springs 17 and 18 formed as tension springs. Line 14, just like supply lines 19 and 20, runs through a stationary axle 21. Supply lines 19 and 20 are also equipped with quickly detachable connections 190 and 200, respectively. Roll shell 3 is clamped in lateral clamping elements 22 and 23, which, together with roll shell 3, are rotatably mounted in ball bearings 24 and 25. On the outside, fixed-location end covers 26 and 27 are mounted in front of clamping elements 22 and 23. The interior of press roll 1 is sealed off with respect to the external region by way of seals 28 and 29.

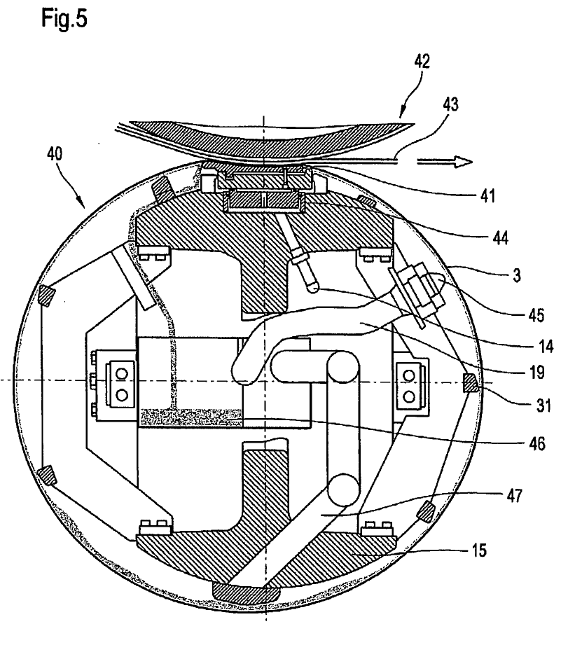

Now, additionally referring to FIG. 4, there is shown a supply line 19 that supplies lubricating and cooling oil, which is under hydrostatic pressure. The lubricating and cooling oil is supplied within press roll 1 to a distributor 30. From distributor 30, the oil is applied to the inner wall of roll shell 3. It is necessary for the contact zone between press rolls 1 and 2 to be cooled, so the oil is particularly supplied there. Supply line 20 removes the oil from press roll 1 in order that it can be cooled again in a cooling apparatus (not illustrated here). Likewise, a filter is incorporated in the oil circuit. Roll shell 3 is held on press roll I in a form that has a circular cross section by shell guide bars 31 connected to load bearing element 15.

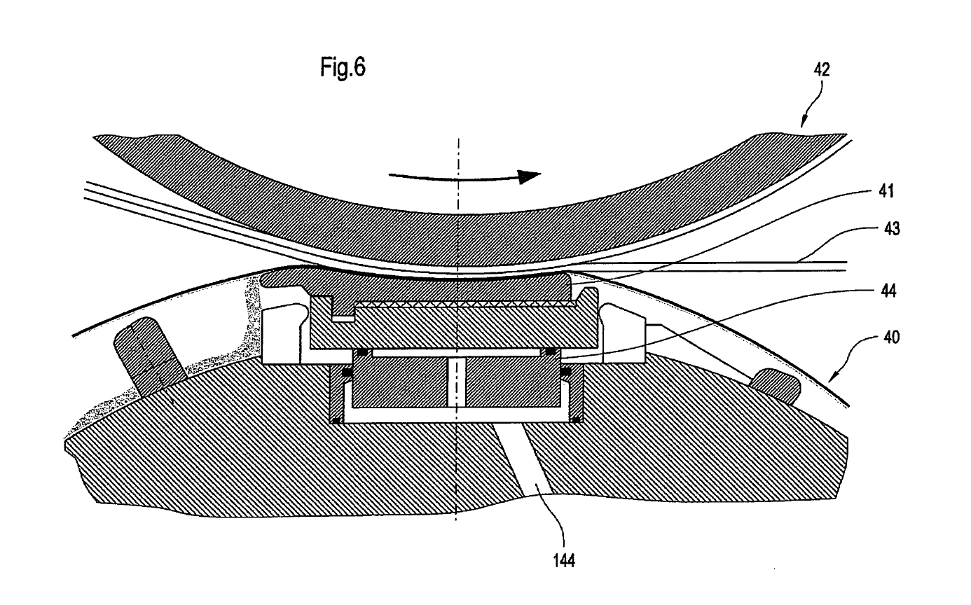

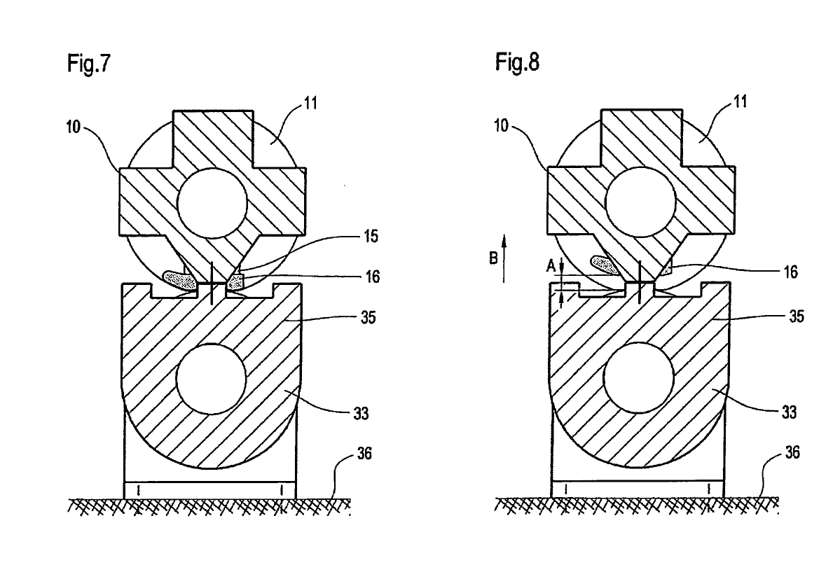

Now, additionally referring to FIGS. 5 and 6 there is illustrated another embodiment of the present invention, in which a press roll 40 with a pressure or supporting shoe 41 is arranged under press roll 42. A material web 43, for example a paper or a tissue web, runs between press rolls 40 and 42. Pressure shoe 41 is pressed against material web 43 by a pressing element 44. Pressing element 44 is raised by way of a fluid, for example hydraulic oil, supplied by line 14, in order to press pressure shoe 41 against material web 43. Pressure shoe 41 is replaceably arranged in load bearing element 15 in a holder 45, which can be moved together with pressure shoe 41. The supply of the hydraulic oil is ensured by connecting lines 14. A lubricating oil distributor 45 applies the lubricating oil, which is supplied by line 19 to the inner wall of the roll shell 3. As a result of the pressure of pressure shoe 41 against the inner wall of roll shell 3, the lubricating oil runs off on the rear flank of roll shell 3, as viewed in the direction of rotation, so that it is collected in an oil collecting container 46. From there, after it has been filtered, it flows onto the inner wall by way of a siphon 47 in the lower region of the interior. Oil collecting container 46 and siphon 47 are connected to load bearing element 15.

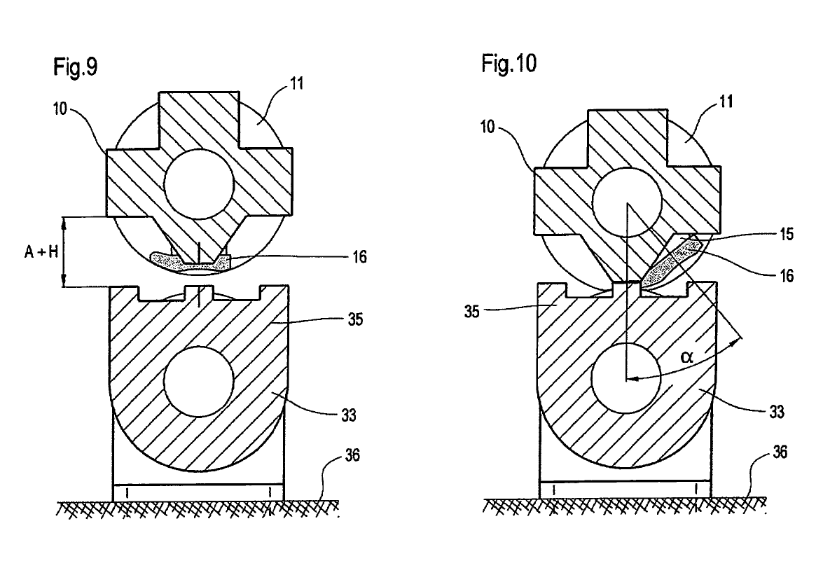

Now, additionally referring to FIGS. 7-10, there is shown another embodiment of the present invention, in which a press roll 11 is arranged in a bearing housing with a bearing wall 10 and having a supporting or load bearing device 15 arranged above press roll 33 used as a backing roll, which is mounted in a bearing wall 35. Bearing wall 35 stands on a base 36. Supporting device 15 has a supporting shoe 16, which, in the operating position, presses the material web against press roll 33. The pressure or supporting shoe 16 can be drawn upward to such an extent that the supporting device 15 can be pivoted past press roll 33.

The displacement travel A needed for this purpose, which is traced upward by supporting shoe 16 in the direction of arrow B, is chosen to be sufficiently large for the necessary spacing from press roll 33. The movement of pressure shoe 16 is achieved, for example, by way of return springs 17 and 18. In order to facilitate or to assist the removal of pressure shoe 16, there is additionally, on bearing wall 10, a hydraulic device (not illustrated here) which additionally raises bearing wall 10 by a distance H.

Alternatively, load bearing device 15 together with pressure shoe 16 is rotated upward by an angle α, as shown in FIG. 10. Bearing wall 10 for press roll 11 is constructed in such a way that, at this angle, it has a cutout through which pressure shoe 16 can be withdrawn from press roll 11 at the end, parallel to the longitudinal axis of press roll 11. During replacement of supporting shoe 16 by another supporting shoe, all the steps are completed in reverse order.

In addition to the possibilities discussed extensively above, within the scope of the invention there are many variants according to which pressure shoe 16 can be removed. These variants can also include, for example, cantilevered displacement of press roll 1, 11 or 40 on one side. As such, supporting or pressure shoe 6 or 16 can be withdrawn from the press roll when no pressing pressure is applied to it by the hydraulic fluid.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A press roll for forming a press nip with an other press roll, comprising:
a rotating roll shell;
a roll axle;
a supporting device connected to said roll axle, said supporting device supporting said rotating roll shell;
an end wall associated with the press roll; and
at least one supporting shoe connected to said supporting device, said at least one supporting shoe removable from the press roll through said end wall.

2. The press roll of claim 1, wherein said supporting device is a load bearing device, said at least one supporting shoe being at least one pressure shoe.

3. The press roll of claim 1, wherein said supporting device is pivotally arranged within said rotating roll shell.

4. The press roll of claim 1, wherein said supporting device is pivoted together with said roll axle.

5. The press roll of claim 1, wherein said supporting device is arranged pivotally on said roll axle.

6. The press roll of claim 1, wherein said supporting shoe is pressed against said rotating roll shell.

7. The press roll of claim 6, further comprising a hydraulic apparatus connected to said supporting shoe to thereby press said supporting shoe against said rotating roll shell.

8. The press roll of claim 1, wherein said rotating roll shell is flexible, said at least one supporting shoe having a concave pressing surface to thereby form an extended press nip.

9. The press roll of claim 1, wherein the press roll is arranged above the other press roll, said supporting device being pivotal about said roll axle between approximately 90° and 270°.

10. The press roll of claim 9, wherein said supporting device is pivotal about said roll axle by approximately 180°.

11. The press roll of claim 1, wherein the press roll is arranged one of under and over the other press roll, said supporting device being pivotal about said roll axle between approximately 90° and −90°.

12. The press roll of claim 11, wherein said supporting device is pivotal about said roll axle between approximately 45° and −45°.

13. The press roll of claim 1, further comprising:
a stationary axle associated with said supporting device;
at least one supply line running through said stationary axle; and
a detachable coupling connected to said at least one supply line.

14. The press roll of claim 1, further comprising a cantilever mount to which the press roll is mounted.

15. A method of changing a supporting device of a press roll, comprising the step of:
removing a supporting shoe that is connected to the supporting device through an end wall of the press roll.

16. The method of claim 15, further comprising the step of pivoting the supporting device from an operating position into a change position prior to said removing step.
